(19) United States
(12) Patent Application Publication
(10) Pub. No.: US 2013/0216983 A1
(43) Pub. Date: Aug. 22, 2013

(54) SYSTEM AND METHOD FOR LEARNING ENGLISH

(71) Applicant: Lior Cohen, Tel Aviv (IL)

(72) Inventor: Lior Cohen, Tel Aviv (IL)

(21) Appl. No.: 13/401,024

(22) Filed: Feb. 21, 2012

(51) Int. Cl. G09B 1/00

(52) U.S. Cl. 434/167

(57) ABSTRACT

The various phonemes of a language to be learned are each assigned a unique color. The student learns to associate a particular color or color group with its particular sound or sound group. Since there are no exceptions, the student will now easily be able to speak a new, previously-unread word (or even language), if the word has been colored correctly with each letter or set of letters representing a phoneme is properly colored with its assigned color.

### BACKGROUND

1. Technical Field

Embodiments of the present invention relate generally to systems and methods for learning language, specifically English.

2. Description of Related Art

Generally a new language is learned starting with its alphabet. Due to various ambiguities such as particular letters or sequences representing more than one sound, and one sound being represented by more than one letter or letter sequence, the learning of the alphabet may be rather more time-consuming than it otherwise need be.

Hence, an improved method for learning English is still a long felt need.

### BRIEF SUMMARY

An aspect of the present invention provides a system for phoneme representation for a language comprising a set of colors, each assigned to a particular phoneme in a one-to-one correspondence, whereby the entire set of phonemes for said language is represented by phoneme-representing colors each uniquely representing a phoneme, thereby preventing confusion due to use of multiple letter representations for a single phoneme as well as multiple phonemes possible for particular letter representations.

It is further within provision of the invention wherein each occurrence of a given phoneme in a text is colored by means of said phoneme-representing colors.

It is further within provision of the invention wherein groups of related phonemes are related by means of related colors.

It is further within provision of the invention wherein said related phonemes are selected from the group consisting of: bilabial, labiodental, dental, alveolar, postalveolar, retroflex, palatal, velar, uvular, pharyngeal, glottal, plosive, nasal, trill, tap, fricative, lateral fricative, approximant, lateral approximant, close, close-mid, open-mid, open, front, central, back

It is further within provision of the invention replacing said colors with textures.

It is further within provision of the invention replacing said colors with patterns.

It is further within provision of the invention replacing said colors with typefaces.

It is further within provision of the invention wherein the international phonetic alphabet is represented by a set of unique colors, thereby allowing for many of the world's languages to be spoken by any speaker familiar with said set of unique colors.

It is further within provision of the invention to implements a method for learning language comprising steps of:
a. assigning each different phoneme of a language a unique color;
b. coloring letters of said language using said colors;
   thereby encoding the phonemes of the written language in said colors, preventing confusion due to use of multiple letter representations for a given phoneme as well as multiple phonemes possible for particular letter representations.

It is further within provision of the invention wherein each occurrence of a given phoneme in a text is colored by means of said phoneme-representing colors.

It is further within provision of the invention wherein groups of related phonemes are related by means of related colors.

It is further within provision of the invention wherein said related phonemes are selected from the group consisting of: bilabial, labiodental, dental, alveolar, postalveolar, retroflex, palatal, velar, uvular, pharyngeal, glottal, plosive, nasal, trill, tap, fricative, lateral fricative, approximant, lateral approximant, close, close-mid, open-mid, open, front, central, back

It is further within provision of the invention replacing said colors with textures.

It is further within provision of the invention replacing said colors with patterns.

It is further within provision of the invention replacing said colors with typefaces.

It is further within provision of the invention wherein the international phonetic alphabet is represented by a set of unique colors, thereby allowing for many of the world's languages to be spoken by any speaker familiar with said set of unique colors.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates a set of related phonemes colored with a set of related colors; and

FIG. 2 illustrates a set of related phonemes colored with a set of related colors; and

FIG. 3 illustrates a set of related phonemes colored with a set of related colors; and

FIG. 4 illustrates a set of related phonemes colored with a set of related colors; and

FIG. 5 illustrates a set of related phonemes colored with a set of related colors; and

FIG. 6 illustrates a set of related phonemes colored with a set of related colors; and

FIG. 7 illustrates a set of related phonemes colored with a set of related colors; and

FIG. 8 illustrates a set of related phonemes colored with a set of related colors; and

FIG. 9 illustrates a set of related phonemes colored with a set of related colors; and

FIG. 10 illustrates a set of related phonemes colored with a set of related colors; and

FIG. 11 illustrates a set of related phonemes colored with a set of related colors; and

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a system and method for learning language using colors.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer e.g, 1, 5, or 10).

The term ‘phoneme’ refers hereinafter to the smallest unit of sound employed to form meaningful contrasts between utterances. For example the phoneme /k/ is the sound that the ‘c’ makes in ‘cat’, as well as the sound that ‘ck’ makes in ‘cricket’ and ‘k’ makes in ‘kill’.

The inventive system is an innovative study method, designed to teach literacy, pronunciation and vocabulary through the use of color-based phonetics.

In this system, the various sounds of the English language are each matched with a color. The student learns to associate a particular color or color group with a particular sound or sound group. Because the sounds repeat themselves in different variations—as single letters or in combination—the student has an easier time recognizing new, previously-unread words, associating between letters and the appropriate sounds, learning correct pronunciation, and expanding his/her vocabulary.

To summarize, the inventive system and method comprise assignment of a unique color to each phoneme in a language. Every time that phoneme is used, it is colored using its assigned color, no matter the particular letters used to form the phoneme in any particular example. Thus for instance the phoneme /k/ might be assigned the color yellow, and this color would be used both for coloring the letter ‘k’ in texts employing the inventive system, and for the letter ‘c’ when ‘c’ is pronounced like a ‘k’ as in the word ‘color’. By the same token the letter ‘s’ may be assigned the color blue for the sound it makes in the word ‘sound’. Thus when a ‘c’ makes that ‘s’ sound as in the word ‘mace’, it is also colored blue. This allows the student of the language to properly pronounce new words simply by memorizing the colors for each phoneme, which are arranged to have no exceptions and thus are easier to learn than the letter representations which often have confusing exceptions and multiple uses. When the letter ‘c’ is used for a /k/ phoneme it is colored yellow while when it is used for an /s/ phoneme it is colored blue, thereby eliminating the confusion otherwise resulting from use of the same letter ‘c’ for both /k/ and /s/ sounds.

The colors in a sense replace pronunciation marks that appear in several languages but not in English, which enable the student to easily distinguish between the various sounds that a single letter or a letter combination can produce. In effect the system implements a type of phonetic alphabet, but one using a parallel channel of color information that does not interfere with the standard textual information, rather rendering text more comprehensible.

One implementation of the invention includes for instance a complete color map for English phonemes. Such an embodiment may further contain a learning program based on the color phonetics concept. The program may for instance be comprised of a series of lessons. In one embodiment each lesson explores five new sounds and uniquely composed poems for further pronunciation practice.

To implement the system and method a list of all phonemes in a language is made. Then each phoneme is assigned a unique color. Although a given phoneme may be written using several different letters or letter combinations (as in the sound /k/ which may be written with the letter ‘k’ as in ‘kangaroo’, or alternatively may be written with a ‘c’ as in ‘class’) the color used to represent this one phoneme is the same. This will make the language less confusing since the color remains constant for a given sound, and the confusing element of multiple spellings for a given sound is ameliorated.

Conversely, a single letter may represent multiple phonemes in a given language, as in ‘ou’ which in the sentence “The tough coughs as he ploughs the dough” is used to represent four different phonemes. Each version of the letter combination ‘ou’ will, in the inventive system and method, use a different color, again making the sentence easier to read since the new reader will not need to rely on context to know what sound the ‘ou’ is supposed to make, but can instead simply recall the phoneme for each color, which have a one-to-one correspondence.

A list of most important English letters and letter combinations, and words containing the various phonemes these letters and letter combinations can produce, is shown here:

VOWELS A, E, I, O, U, etc:

| | |
|---|---|
| A | bat/hard/all/mate |
| E | egg/English/eye/silent/café |
| I | bin/ice |
| O | dog/old/move/love/one/women |
| U | cut/u put/u cute/u busy/u bury |
| ee | been |
| ae | aero/hyaena/vitae |
| aw | raw/wall/was |
| ew | blew/few/sew |
| oo | book/blood/door |
| ea | bear/ear/earn/break |
| au | haul |
| oa | oak/board |
| ai | hair/main/mountain/aisle |
| ie | lie/movie |
| ei | weigh/ceiling/foreign/height/heir |
| eo | people/pigeon |
| ou | house/four/tour/rough/though/dangerous |
| oe | shoe/toe |
| ow | low/now |
| ui | guide/suite/fruit/build/circuit |
| ue | blue/argue/guest/silent/suede |
| uo | fluorescent/liquor |
| oi | choir/memoir/coin |

CONSONANTS:

| | |
|---|---|
| c | cat/center/ocean |
| cc | occur/accent |
| t | tent/beauty |
| tt | better/watt |
| f | fat/of |
| g | get/page/garage |
| s | is/sun/parents/asia/sugar/silent |
| y | money/by/try |
| x | box/exhaust |
| wh | what/whole |
| qu | queen/Iraq/mosquito/antique |
| th | open the/closed thunder/Thailand |
| er | father/doctor/girl/beggar/burn |
| ck | clock |
| ch | chicken/school/chef |
| sh | shy |
| sc | scent/score |
| ss | pass/dessert/assure |
| gh | silent/tough/ghost |
| ph | phone |
| ture | future/treasure |
| tion | action/attention |
| sion | television/passion/pension |
| cion | coercion/suspicion |

As will be appreciated there is considerable overlap represented in this list, of two kinds; the same phoneme may be represented by different letters (the ‘a’ in all and the ‘o’ in dog) and the same letter may represent different phonemes (the ‘o’ representing different phonemes in each of the words ‘dog’, ‘old’, ‘move’, ‘love’, ‘one’, ‘women’.

Thus to deal with these ambiguities a one-to-one system for phoneme representation is provided based on representing each phoneme uniquely with a unique color. As will be clear to one skilled in the art, the color may also be substituted by texture, font, appearance, animation, or the like.

It is within provision of the invention to teach a language such as English using the concepts described above in several lessons, examples of which are given below.

LESSON 1

| | | | | |
|---|---|---|---|---|
| A/a - | I/i - | P/p - | N/n - | T/t - |
| at | it | pin | nip | tin |

LESSON 2

| | | | | |
|---|---|---|---|---|
| O/o - not | s - | H/h - | D/d - | M/m - |
| | is | hat | dot | mad |

These new phonemes are assigned colors, and a reading segment is given that requires use of the phonemes such as that below:

### Tom and Dan

Tom is not an ant. Tom is a man.
Tom has a dad. His dad is Dan.
Tom has a pin and a tan.
Dan has ham in a hot pan.
Tom has a map and a pot on top.
His pot has a dot. Tom has a mop.
Dan is not mad. Dan has a hat.
His hat is in his hand. It is not on a mat.
Tom did not nod at Dan.
Dan is a dad. Dan is a man.

LESSON 3

| | | | | |
|---|---|---|---|---|
| U/u - up | R/r - | E/e - | C/c - | B/b - |
| | rat | bet | cat | bat |

These phonemes are assigned colors, and a reading segment is given that requires use of the phonemes such as that below:

### Ben

Ben is a man. Ben has a rib and a hip.
Ben is not in a cab. Ben is on a trip.
On his trip Ben met men.
Ben met Rob, Rod and Ted at ten.
Ben is in a tent.
It is a tent Ben did not rent.
His tent is not a tub or a hut.
Ben has a cup, a bun and a nut.
Ben had a crab in a net, not in a tin can.
His net is torn. Ben cut it and the crab ran.

### Bob

Bob is in his den. In his den Bob has a pen.
Bob has a pet but it is not a hen.
His pet is not a crab or a bat.
His pet is not a cub. His pet is a cat.
His cat can run. It can run in mud or on a mat.
His cat is not bad. His cat can hunt a rat.
Bob has a dad. His dad has a band.
His dad has a drum in his hand.
Bob has a trumpet. His trumpet is red.
At ten Bob is not up. At ten Bob is in bed.

LESSON 4

| | | | | |
|---|---|---|---|---|
| Th/th - | L/l - | K/k - | F/f - | S/s - |
| the | let | kid | fat | sit |

These phonemes are assigned colors, and a reading segment is given that requires use of the phonemes such as that below:

### Frank

Frank is not fat. Frank is a slim kid.
Frank has a fork, a cork and a flat lid.
Frank can drink milk. Skim milk is the best.
If frank has a test, Frank must rest.
Frank is not on a raft or in a tank.
Frank is not in a lab or at the bank.
Frank can sit or run fast in the sun.
Frank is fit. For Frank this is fun.
Frank has flip-flops. Frank can step on soft sand.
Frank can stop and rest. Frank can lift his left hand.

### Sam

Let us not forget. Sam is not sad or upset.
Sam has fun. Sam can ski until sunset.
Sam has red lips and his skin is pink.
Sam has a plastic pen on his desk. The pen has ink.
Sam is not an insect or a stork in a nest.
Sam is a man, not a skunk in a forest.
Sam can scrub himself in the tub.
Sam is not in a club. Sam is not on a sub.
Sam can act in films. On the set his fans must let him rest.
Sam can wink at us and ask, “is it not the best?”

LESSON 5

| | | | | |
|---|---|---|---|---|
| A/a - | ck - | W/w - | ee - | G/g - |
| hard | clock | was | see | dog |

These phonemes are assigned colors, and a reading segment is given that requires use of the phonemes such as that below:

### Mark

Mark is glad. Mark has a car.
His car has gas. His car can get him far.
Mark has a career. His career is his art.
Mark is a big rock star. Mark is strong and smart.
Mark has luck. In a bar, Mark can sing a song.
His fans can sing along. His song is not long.
Mark can hug his fans. His, fans can hug him back.
Mark has a scarf on his neck. It is green, not black.
Mark has a dog. The dog is big and it can bark.
In the spring, Mark can run with his dog in the park until it is dark.

### Greg, the Green Frog

Greg was born green. Greg is a green frog.
Greg can sit on a log. Greg is not lost in the fog.
Greg is not a pig. Greg is not hog.
Greg is not a bug or a dog. Greg is in a bog.
Greg feels the wind. Greg sees a bee on a tree.
The bee has wings and a sting. The bee is free.
Greg can see a deer. Greg and the deer can meet.
The deer has speed. It has strong legs and feet.
Greg can meet a duck in the morning.
Greg can greet the duck. The duck is not boring.

### Rick

Rick has a blog on the web. Rick is sweet.
Rick is in his apartment. Rick is not on the street.
In his apartment, Rick has a carpet and a rug.
Rick has a clock, fifteen golf clubs and a mug.
Rick has strong arms. Rick can drag a bag from the market.
Last week, Rick went in his truck. Rick needed a rag and a bucket.
Rick wanted beef, garlic, gum and an alarm clock.
Rick did not bring back a ring, a card or a sock.
Rick is not in his garden. Rick is asleep.
Rick sleeps on his back. His sleep is deep.

LESSON 6

| | | | | |
|---|---|---|---|---|
| oo - | J/j - | A/a - | ll - | ss - |
| book | jar | all | ball | kiss |

These phonemes are assigned colors, and a reading segment is given that requires use of the phonemes such as that below:

### Jim

Jim is a cool man. Jim is not a fool.
Jim has a drill. A drill is a big tool.
Jim has a job. Jim has a stall at the mall.
Jim is the boss. Jim is tall and the stall is not small.
Jim sells dolls with dresses and bells, but that is not all.
Jim sells balloons and spoons as well. Jim sells umbrellas in the fall.
Jim can roll or toss a ball. Jim can let it fall.
Jim is in his room on the roof. Jim is not in the hall.
Jim can call Bill and tell him, “Jim is ill.”
Jim is not well. Jim just took a pill.

### Will and Jill

Will is a groom. Will will wed Jill.
Will can miss Jill. Jill can kiss Will.
Jill is in the bedroom, not in a classroom.
The bedroom has walls, a stool and a broom.
The bedroom is not in a mess. The wall has a socket.
Will has a boot on his foot and a jacket with a pocket.
The jacket is on a hook. Jill can look at a book.
Will can fill a jar with jam or salt. Will can cook.
Junk food is not good for Jill and will.
Jill and Will can swim in the pool or jog on a hill.

### Jack

Jack is not a gull. Jack is a baboon.
Jack will peel a banana soon.
Jack can look at the moon.
Jack will not see the moon at noon.
Jack is not on a hill. Jack is in the wood.
Jack is in a good mood. Jack can look for food.
Jack can smell his food and drool.
If Jack is warm, Jack can cool himself in a pool.
Jack can jump on his foot. Jack can jump on a tree.
Jack can sit on the grass. Jim is free.

LESSON 7

| | | | | |
|---|---|---|---|---|
| U/u - | y - | X/x - | sh - | Th/th - |
| put | yes | box | shop | bath |

These phonemes are assigned colors, and a reading segment is given that requires use of the phonemes such as that below:

### Ray

Ray is not yet fifteen but Ray is not a boy.
Ray will not play with a toy.
Ray was born on a Sunday in May.
Ray is not in a taxi but Ray will not stay.
Ray is on a gray ship. Ray is on his way.
The gray ship is not in a marsh or a bay.
Ray sees a shark, a shrimp and a fish.
For a shark, a fish is a good dish.
The shark has six sharp teeth. The shark has thick flesh.
Sharks always wish for a fish that is fresh.

### Josh

Josh is a guy. Josh is good at math.
Josh is in his shop. Josh is not in his bath.
Josh may sell or buy things. Josh always pays in cash.
Josh has a box in his shop and a can for trash.
On a shelf Josh has a shampoo, a brush and spray.
Josh has a tray with yams. Josh may lay the tray.
Josh can mix three drinks at six. Josh must pay his tax.
Josh may pray. Josh may play his sax.
Josh can fix his car. On his car Josh can put wax.
Josh can polish his car. Josh may send a fax.

### Roy and Ruth

Ruth is with Roy and Roy is with Ruth.
Roy is short and Ruth has long lashes. This is the truth.
Roy can say, “hey, Ruth!” Yes, this is Roy.
Roy can thank Ruth. Ruth brings Roy joy.
Ruth is not a sheep. Roy is not an ox.
Ruth is not a student. Roy is not a fox.
Roy has strength. Roy is as strong as a bull.
Ruth has a box that Roy can push or pull.
Ruth and Roy can finish this text.
They will not finish the text that is next.

LESSON 8

| | | | | |
|---|---|---|---|---|
| Y/y - | V/v - | o - | Ch/ch - | e - |
| ugly | van | move | chin | silent |

These phonemes are assigned colors, and a reading segment is given that requires use of the phonemes such as that below:

### Andy and Wendy

Wendy is a woman. Wendy lives with Andy.
Every day Andy gives Wendy a candy.
Andy is not clumsy. Andy is not angry.
Wendy is not a witch. Wendy is not scary.
Wendy is not in the army. Andy is not in the military.
Andy is not at a party. Andy works in a factory.
Wendy works as a vet in a clinic. Wendy has a salary.
The clinic is not empty. In the clinic there is a canary.
There are chimps in the clinic. Every chimp has a chest, a chin and cheeks.
In the clinic there are chipmunks, a wolf, chickens and chicks.

### Billy and Kelly

Billy and Kelly are not rich. They live on a ranch.
They can sit on a branch. They can watch a canary on a branch.
A canary can catch a worm. It can catch twenty.
A hungry canary can catch forty or fifty worms. It can catch plenty.
Billy and Kelly are very lucky. They have a big family.
They have many children: Lily, Willy, Shelly and Emily.
They may have lunch on the balcony, if it is not chilly.
They may have lunch in the kitchen. They may have chips and chili.
Kelly can forget to give Billy an olive. Billy can forgive Kelly.
Kelly did not forget to give it to him. The olive is in his belly.

### Randy

Randy is not seven. Randy is seventeen.
Randy has a vest. Randy has cheeks, a chest and a chin.
Randy is not a scary bully. Randy is not ugly or silly.
Randy has a visa. Randy can see the world and visit Italy.
Randy can do many things. Is there anything Randy will not do?
Randy can give a speech, chant or chat. Randy can put on an shoe.
Randy can sit on a porch with a torch. Randy can study world history.
Randy can tell a story with many words. Randy has a good memory.
If Randy plays chess, Randy may win or lose.
Randy can move in a van or a canoe. Randy can lose expensive shoes.

LESSON 9

| | | | | |
|---|---|---|---|---|
| G/g - | C/c - | Z/z - | A/a | e - |
| page | race | zit | face | Magic E |

These phonemes are assigned colors, and a reading segment is given that requires use of the phonemes such as that below:

### Jake

Jake is not a baby. Jack has a zit on his face.
Jake can play a game. Jake can run in a race.
Jake lives in a city, not in a strange place.
Jake can visit the zoo. Jake is not in space.
At the zoo Jake can stare at a rare snake.
Jake is very brave. That snake will not scare Jake.
Jake can feed the snake grapes. Jake gave it cheese.
Jake can feel a breeze. Jake will not freeze but Jake can sneeze.
The snake is in a large cage. The snake may try to escape.
The snake can swim in a lake. The snake is in good shape.

### Cindy

Cindy is a lady, not a male. Cindy is a name.
Cindy is not Mandy. The names are not the same.
Cindy will not wake up late. Cindy is not lazy.
Cindy is awake. Cindy is not crazy.
Cindy is pale. Cindy can tell a legend or an amazing tale.
Cindy may take a plane to Zanzibar if the ticket is on sale.
Cindy is able to watch cables and bake a cake on the same date.
Cindy can celebrate. Cindy can dance and skate.
Cindy can have a milkshake and cake on a plate.

### Zack and Liz

Zack is not a prince. Liz is not a princess from France.
Zack and Liz want to fly there, if they get a chance.
Zack and Liz are classmates. They are in the same grade.
Zack and Liz can shut the drapes. They can sit in the shade.
Zack and Liz are the same age. They can stare at the same page.
Zack and Liz are not in the gym. They are not on a stage.
Zack and Liz have braces. They can share the same toothpaste.
Zack and Liz can share an orange. They have an excellent taste.
Zack and Liz hate celery. They do not have it on the table.
They are unable to put it there. The table is shaky and unstable.

LESSON 10

| | | | | |
|---|---|---|---|---|
| -ie | -ie | -gh | Wh/wh - | I/i |
| lie | cookie | high | what | ice |

These phonemes are assigned colors, and a reading segment is given that requires use of the phonemes such as that below:

### Ira and Diana

Ira is not a whale. Ira is not a swine.
Ira has a left thigh and a right thigh. Ira has a spine.
Ira can invite Diana to a movie. Diana is his niece.
Ira has a cookie. Ira might give Diana a piece.
Diana has a pie. Diana might give Ira a slice.
Ira and Diana might dive twice, fly a kite or play with dice.
Where are Ira and Diana? Ira and Diana are standing in line.
Ira and Diana want to ice-skate until nine.
Ira might play the violin for Diana at night.
The moon shines at night. The light is very bright.

### Mike

Mike is a quiet man. Mike has a bride.
Mike has a spare wheel and a bike mike can ride.
Mike works for the police. Mike has a shield and a tie.
Mike believes in justice. Mike dislikes men that lie.
Mike can fight a thief at night. The thief may try to hide.
Mike can find the thief. The thief is by his side.
Mike can tie the thief. The thief is not nice.
Mike is not tired. The thief must pay the price.
Mike can give the thief an advice:
Do not make the same mistake twice.

### Iris

I am Iris. I am wise and kind.
Iris is my name. I am not blind.
I am not a child. My age is not five.
I have a wide smile. I am alive.
I have a husband. I am his wife.
My husband and I live a nice life.
My husband and I like to dine at nine.
My husband and I like white rice and wine.
My husband likes to hike or ride his bike. I like to ride mine.
I do not have a flat tire. My bike is fine.

LESSON 11

| | | | | |
|---|---|---|---|---|
| -Er/er | -o | -E/e | Ph/ph - | O/o |
| worker | love | scene | phone | old |

These phonemes are assigned colors, and a reading segment is given that requires use of the phonemes such as that below:

### Phil and Daphne

Phil and Daphne are here. Both Daphne and Phil are clever.
Phil and Daphne are so in love. They want to be together forever.
Daphne adores Phil. Phil adores Daphne even more.
Daphne never ignores Phil. Phil does not ever snore.
Phil can tell Daphne a secret. Daphne can tell Phil a joke.
Phil can light a bonfire on the shore. Daphne can see the smoke.
Phil and Daphne are here. They are not in the desert or by a river.
Daphne has a body so she has fingers, toes, bones and a liver.
On her finger Daphne has a gold ring. The ring is not silver.
If Phil shivers, maybe Phil has a high fever.

### Joe

Joe has a big toe. Joe is not alone.
Joe has a dog. His dog has a bone.
Joe is only eleven, not even twelve. No, he is not old.
Joe is not in the north pole. No, he is not cold.
Joe can go home. At home he can play the piano.
At home he has a sofa and a radio. He can also play domino.
Joe has a dozen roses. He can hold a rose and smell it with his nose.
Joe can give those roses water. He can water those roses with a hose.
Joe is on the phone. He can say, “hello!”
He can say, “call me later. I must go.”

### Peter

Peter has a father. Peter is his son.
Does Peter have another father? No, he has none.
His father is a barber and his name is Steve.
Peter also has a mother. She is a dancer and her name is Eve.
Peter has a brother and a sister. Both are older than Peter.
His brother is a clerk. His sister is a singer.
If the sister has a concert, Peter and his brother go together.
Both the mother and the father will love them forever.
Peter can go to the grocery store with some money.
Peter can buy a potato, a tomato and some honey.

LESSON 12

| | | | | |
|---|---|---|---|---|
| - or | Oa/oa - | Ai/ai - | Ea/ea - | U/u |
| doctor | toad | main | ear | cute |

These phonemes are assigned colors, and a reading segment is given that requires use of the phonemes such as that below:

### Daisy

Daisy is a doctor. Her Job is not plain.
Her main goal is to treat men in pain.
Daisy is not in jail. Daisy can paint a nail.
Daisy is cute and she has braids. Daisy can read her mail.
Daisy is not a snail, an eagle, a roach or a goat.
Daisy has a uniform. She has a long, white coat.
Daisy will aid a man if she hears him complain.
If a man has a disease, a man may be in pain.

### Hector

Hector teaches at the university. Hector is a professor.
Hector has a brain, a throat and ears. He is not an actor.
Hector uses soap. It means that Hector is clean.
Hector is cute. It is clear that Hector is not mean.
Hector has a beard. He can shave it with cream and a razor.
Hector can loan a book to a student. He can do the student a favor.
Hector has a student. She can read and speak but she does not cheat.
The student can wait for an elevator. During the class she is in her seat.
The student uses a computer. The computer has a monitor.
It is easy to use a computer. The computer may have an error.

### Dean

Dean is not weak. Dean has a beard and he is lean.
Dean has a stain on his coat. His coat is not clean.
Dean is not a doctor. He is not a tailor.
Dean is on a boat at sea. He is a real sailor.
The boat can float at sea. Dean likes to sail east.
Dean does not like to sail west. He likes it the least.
The boat is not in a harbor. The boat is not near a coast.
Dean is not on the beach. He can eat beans and a toast.
Dean can eat a meal and drink tea. He is in his seat.
Dean can eat ice cream, peas, peaches or meat.

LESSON 13

| | | | | |
|---|---|---|---|---|
| - ir | Ow/ow - | ui - | Ai/ai - | Ou/ou |
| girl | own | build | air | house |

These phonemes are assigned colors, and a reading segment is given that requires use of the phonemes such as that below:

### Clair

Clair is not a fairy. Clair is a girl with a skirt.
Clair has a yellow blouse. She does not have a shirt.
Clair can sit in a chair. Clair has long hair.
Clair has a quiz. She thinks it is not fair.
Clair can play the guitar. Clair can shoot a bow and arrow.
Clair can borrow a book. Clair can throw a pillow.
Tomorrow Clair can go see a show.
Clair can sit in the first row.
Clair can make a sound with her mouth. Clair is very proud.
Clair can open her mouth and shout. Her shout is very loud.

### The Song about the Mouse

This song is about a mouse.
The mouse lives in a house.
Inside the house there are stairs, a couch and a chair.
The mouse can open a window and breathe air.
The house is not on a cloud. The house is on a mountain.
The house is in the south. Outside the house there is a fountain.
The mouse has a round snout.
The mouse is not a hound dog or a boyscout.
The mouse is not a bird. The mouse is not a crow.
The mouse is not dirty. The mouse is not slow.

LESSON 14

| | | | | |
|---|---|---|---|---|
| - ar | Ow/ow - | Ea/ea - | - Oi/oi | - ui |
| liar | owl | heavy | coin | suit |

These phonemes are assigned colors, and a reading segment is given that requires use of the phonemes such as that below:

### Heather

Heather has steady hands. Heather is healthy.
Heather has a dollar and a coin. Heather is not wealthy.
Heather can make some noise. Heather has a powerful voice.
Heather can join a popular band if that is her choice.
Heather can show how to boil oil. Heather is ready.
Heather has boiled oil a thousand times already.
At night Heather can hear a wolf howl.
At night Heather can see an owl.
At night Heather wears a gown.
Heather is not a spoiled princess. She does not wear a crown.

### Howard

Howard is not a coward. Howard is a clown.
Howard wears a suit. His suit is brown.
Howard is not a cow, lizard or a polar bear.
Howard is not a liar. I swear!
Howard is in a tower. The tower is in a town.
Howard wears a hat. He can put it down.
Howard has a feather in his hat. Now the hat is on his head.
Howard drinks juice. He can eat a fruit or mustard and bread.
Howard can bow before his crowd. He can throw the crowd a flower.
Howard can put on a towel after he takes a shower.

LESSON 15

| | | | | |
|---|---|---|---|---|
| - ur | l - | ou - | - ew | - au |
| purse | silent | could | new | taught |

These phonemes are assigned colors, and a reading segment is given that requires use of the phonemes such as that below:
Could, would, should, talk, walk, half, calf, calm, sidewalk, stalk, palm,
Fur, purple, purse, nurse absurd, surf, curb, burp; juror, burn, turn, burst, curse, hurt, curls, church, suburbs, murder, survey, burglar, curves, urgent, urge,
You, should, would, could, through, tour, pour,
Haul, Saul, auto, pause, vault, sauce, audio, aura, fault, taught, caught, saucer, cause, because, laundry, naughty, author, Few, new, news, nephew.

### Audry

Audry is not an author. Audry is a nurse.
Audry is not a juror. Audry has curls and a purple purse.
Audry walks on the sidewalk.
Audry runs into her nephew and pauses. They talk.
Her nephew has urgent news for her:
When he was doing his laundry he saw a flying saucer.
Then he saw a spaceman. The spaceman had a big palm.
The spaceman could talk and walk. He told the nephew to be calm.
The spaceman did not hurt the nephew.
The spaceman wanted to be taught something new.

To summarize the inventive system and method comprise assignment of a unique color to each phoneme in a language. Every time that phoneme is used, it is colored using its assigned color, no matter the particular letters used to form the phoneme in any particular example. Thus for instance the phoneme ‘k’ might be assigned the color yellow, and this color would be used both for ‘k’ and for ‘c’ when ‘c’ is pronounced like a ‘k’ as in the word ‘color’. By the same token the letter ‘s’ may be assigned the color blue for the sound it makes in the word ‘sound’. Thus when a ‘c’ makes that ‘s’ sound as in the word ‘mace’, it is also colored blue. This allows the student of the language to properly pronounce new words simply by memorizing the colors for each phoneme, which are arranged to have no exceptions and thus are easier to learn than the letter representations which often have confusing exceptions and multiple uses.

As will be appreciated by one skilled in the art, it may be possible to use textures, grayscale shades and the like instead of color to uniquely represent phonemes in the same way as described above but without requiring color which may prove expensive e.g. for printed matter. Thus different levels of cross-hatching, fonts, patterns, color tones, half tones or the like may be substituted for different colors in all of the foregoing explanations.

As will further be understood by one skilled in the art, by means of representing all the phonemes in the international phonetic alphabet (IPA), the present invention can actually allow all phonemes of all languages to be uniquely represented. This would in principle allow anyone who has learned the IPA colormap to speak any foreign language in any alphabet simply by color the letters appropriately. As will be understood this may constitute a true leap forward in language learning, allowing people to nearly instantly speak any new language without any investment other than the initial memorization of the phoneme colormap. The IPA symbols are shown below:

As will be appreciated nearly all phonemes of all human languages have been represented in the IPA shown above, which is limited to a relatively small number of symbols, perhaps 35 main symbols sufficing to represent 99% the phonemes in 99% of all human languages. By assigning a unique color to each of these symbols, the phonemes required for speaking nearly all human languages can be captured. Then by means of coloring the letters of a given language according to these colors, a naïve speaker will suddenly be able to speak nearly any human language using its own native script.

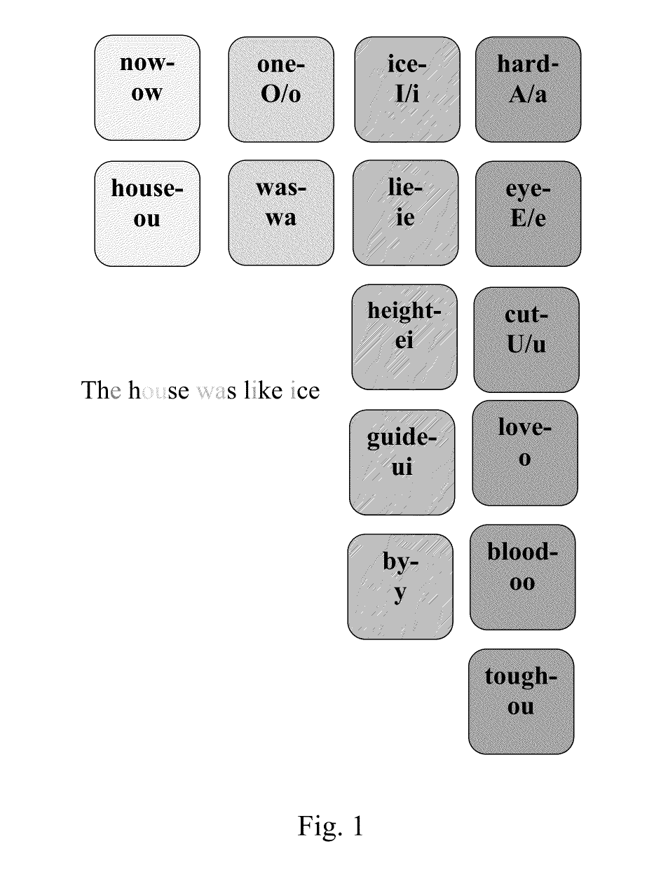

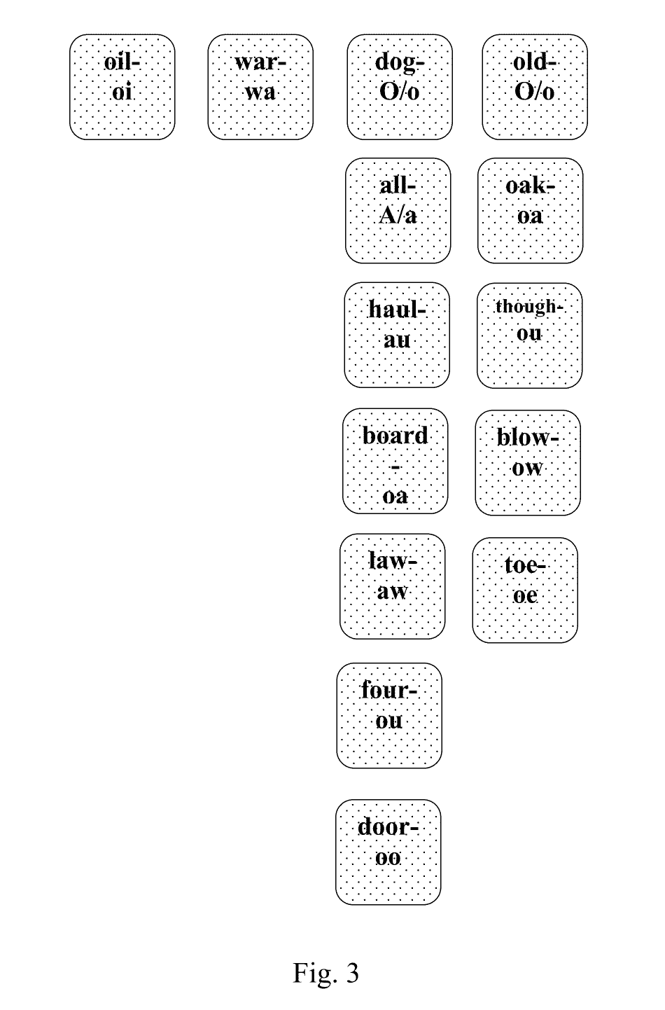

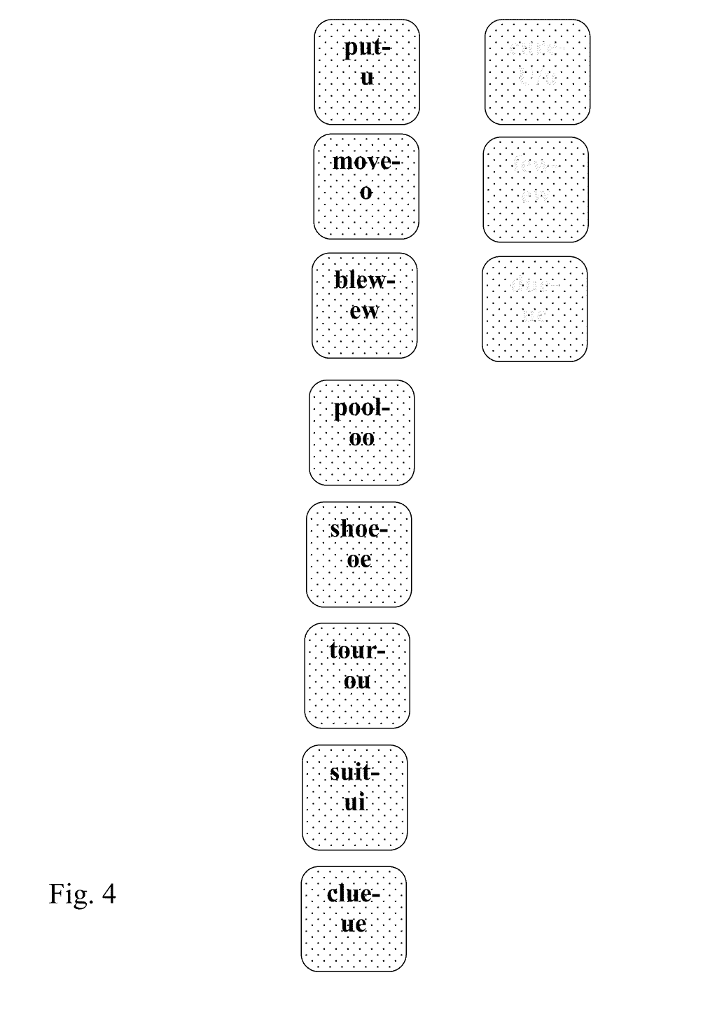

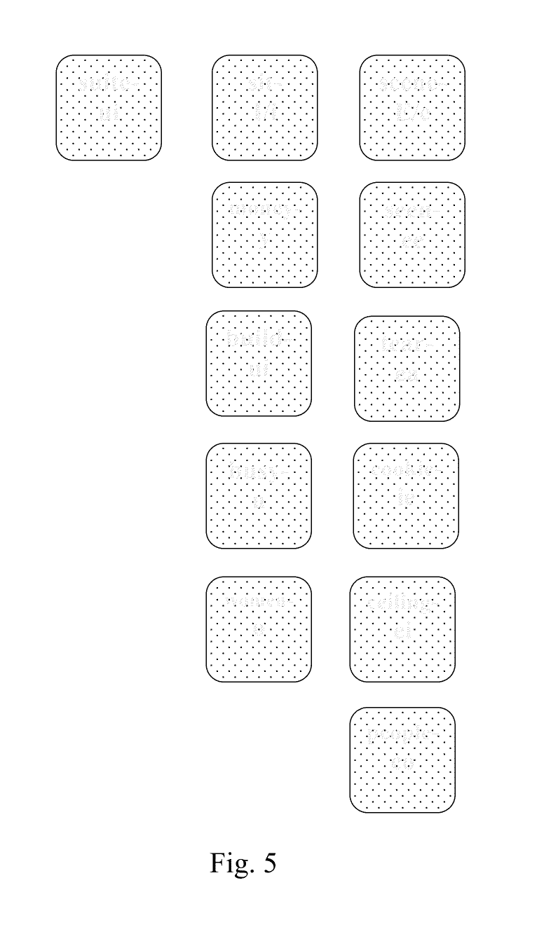

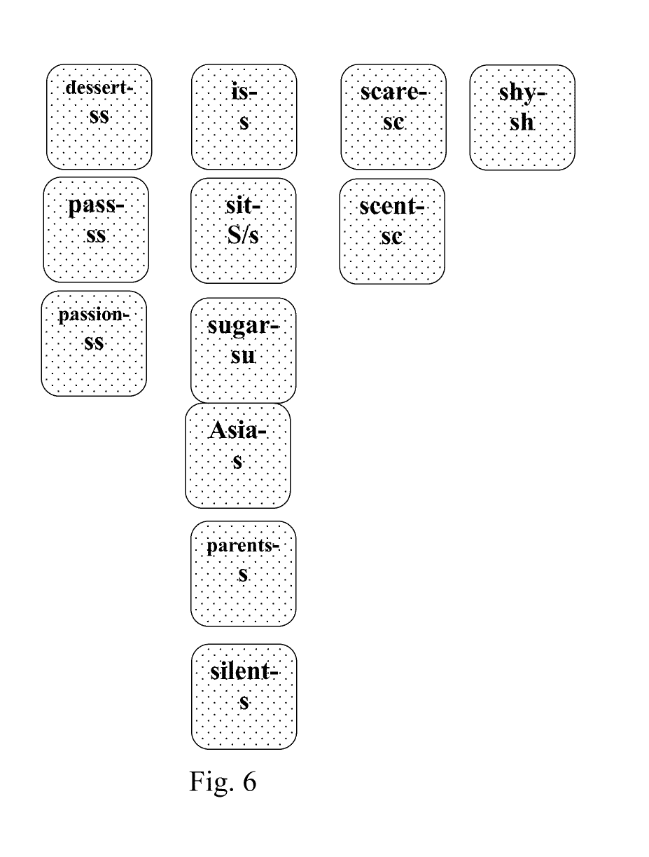

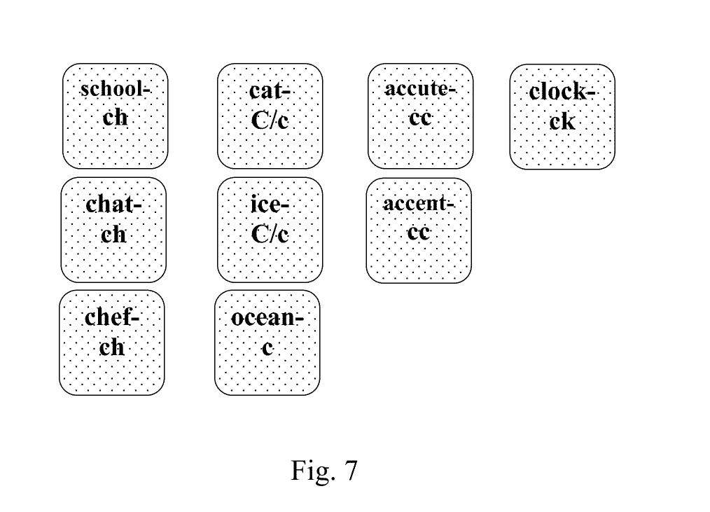

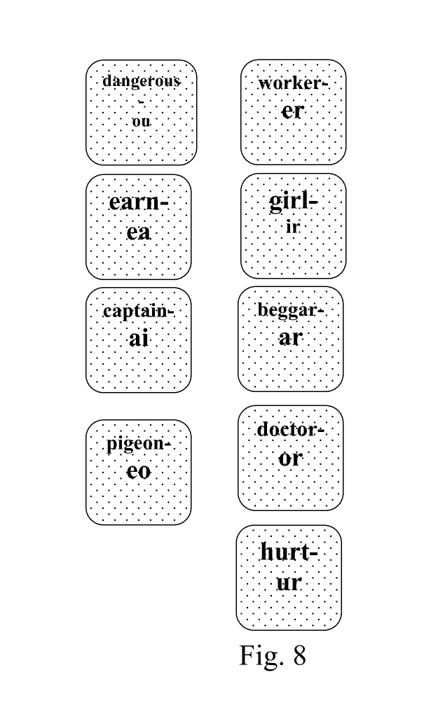

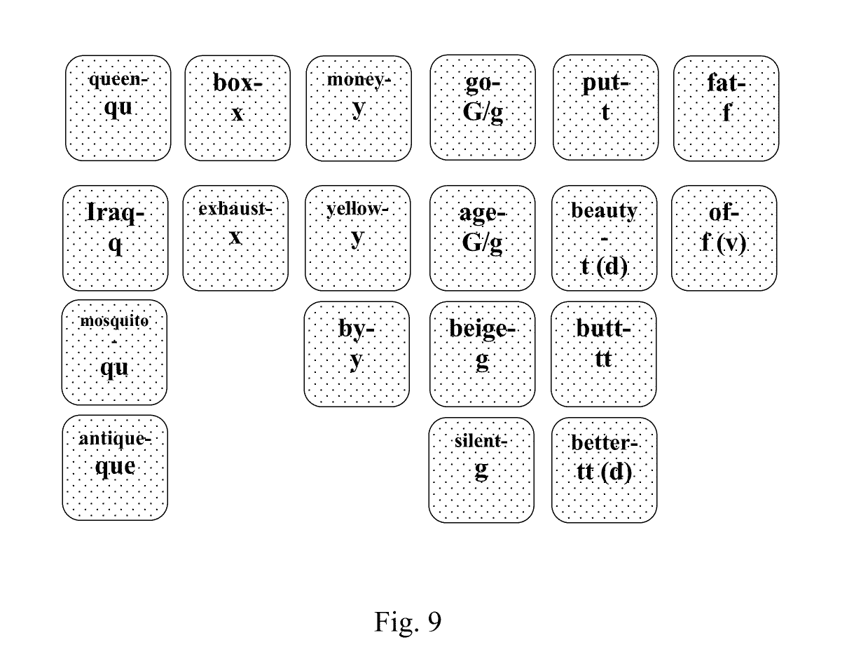

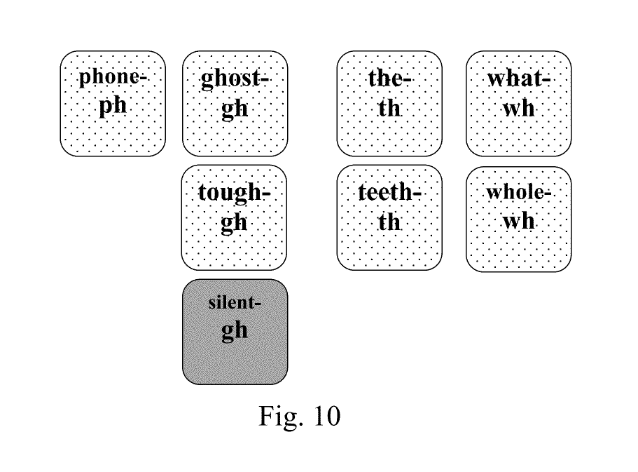

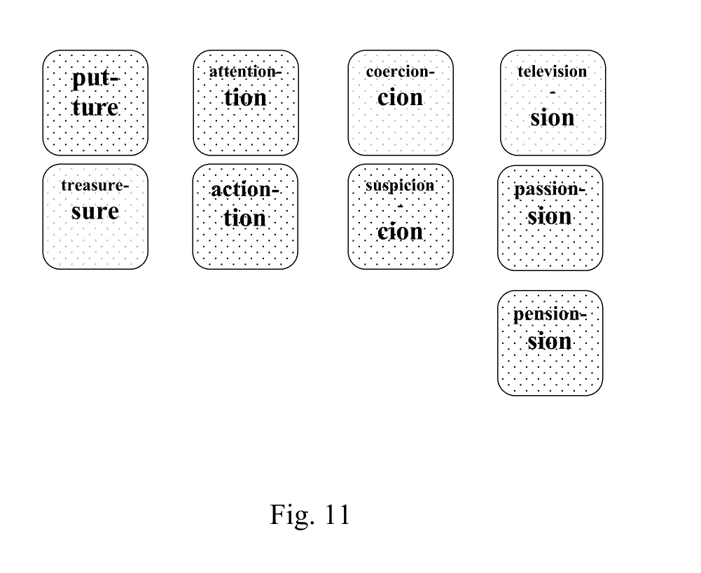

In FIGS. 1-11 a set of colors has been assigned to a set of phonemes. Each figure represents a particular phoneme. FIG. 1 uses shades of green to represent the related phonemes ow, o, I, a, occurring in ‘now’, ‘one’, ‘ice’, and ‘hard’ respectively. The second row and subsequent use the same colors for the same phonemes despite the fact that the phonemes are represented with different letter combinations (for example, the long I in ‘ice’ may be spelled using ‘I; as in ice, ie as in lie, ei as in height, ui as in guide, and y as in by. Thus as an example of the system in action, the sentence ‘The house was like ice’ has been rendered partially using shades of gray indicated in FIG. 1; the ‘ow’ sound getting a very light tone, the ‘wa’ sound getting a darker one, the ‘I’ in like and ice getting a yet darker tone, all according to the scheme shown in the Figure.

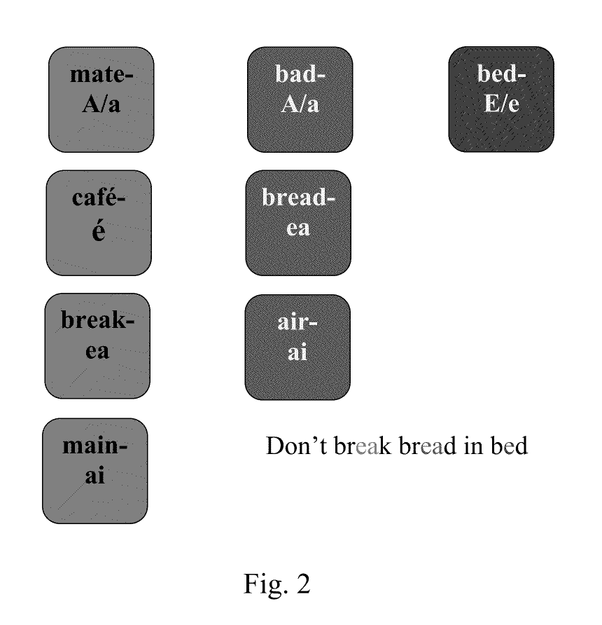

FIG. 2 uses different shades of gray likewise to represent the phonemes long a, short a, and short e as in ‘mate’, ‘bad’, and ‘bed’. As before the second row and subsequent use the same colors for the same phonemes despite the fact that the phonemes are represented with different letter combinations. The example sentence ‘Don't break bread in bed’ has been rendered using the color scheme indicated for the letters ‘ea’ in break and bread, and the letter ‘e’ in bed.

As will be appreciated this underscores the utility of the system, namely that the exceptions and multiple-occurrences that are taken for granted in modern written languages are entirely eliminated without eliminating the letters themselves or replacing the alphabet with an unfamiliar one such as the IPA.

Similarly the remaining figures use different colors for different phonemes, where an attempt has been made to group similar phonemes using different textures. In practice textures and colors, as well as background colors, background textures, fonts, and the like may all be used for such purposes. For example, all the fricative phonemes may be represented by shades of blue or using left-leaning cross hatching, or both.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

What is claimed is:

1. A system for phoneme representation for a language comprising a set of colors, each assigned to a phoneme in a one-to-one correspondence, wherein the entire set of phonemes for said language is represented by phoneme-representing colors each uniquely representing a phoneme, thereby preventing confusion due to use of multiple letter representations for a single phoneme as well as multiple phonemes possible for particular letter representations.

2. The system of claim 1 wherein each occurrence of a given phoneme in a text is colored by means of said phoneme-representing colors.

3. The system of claim 2 wherein groups of related phonemes are related by means of related colors.

4. The system of claim 3 wherein said related phonemes are selected from the group consisting of: bilabial, labiodental, dental, alveolar, postalveolar, retroflex, palatal, velar, uvular, pharyngeal, glottal, plosive, nasal, trill, tap, fricative, lateral fricative, approximant, lateral approximant, close, close-mid, open-mid, open, front, central, back

5. The system of claim 2 replacing said colors with textures.

6. The system of claim 2 replacing said colors with patterns.

7. The system of claim 2 replacing said colors with typefaces.

8. The system of claim 2 wherein the phonemes of international phonetic alphabet are represented by a set of unique colors, thereby allowing for many of the world's languages to be spoken by any speaker familiar with said set of unique colors.

9. The system of claim 2 wherein the phonemes of the international phonetic alphabet are represented by a set of unique textures.

10. A method for learning language comprising steps of:
a. assigning each different phoneme of a language a unique color;
b. coloring letters of said language using said colors;
thereby encoding the phonemes of the written language in said colors, preventing confusion due to use of multiple letter representations for a given phoneme as well as multiple phonemes possible for particular letter representations.

11. The method of claim 10 wherein each occurrence of a given phoneme in a text is colored by means of said phoneme-representing colors.

12. The method of claim 11 wherein groups of related phonemes are related by means of related colors.

13. The method of claim 12 wherein said related phonemes are selected from the group consisting of: bilabial, labiodental, dental, alveolar, postalveolar, retroflex, palatal, velar, uvular, pharyngeal, glottal, plosive, nasal, trill, tap, fricative, lateral fricative, approximant, lateral approximant, close, close-mid, open-mid, open, front, central, back

14. The method of claim 11 replacing said colors with textures.

15. The method of claim 11 replacing said colors with patterns.

16. The method of claim 11 replacing said colors with typefaces.

17. The method of claim 11 wherein the international phonetic alphabet is represented by a set of unique colors, thereby allowing for many of the world's languages to be spoken by any speaker familiar with said set of unique colors.

18. The method of claim 11 wherein the phonemes of the international phonetic alphabet are represented by a set of unique textures.
